(19) United States
(12) Patent Application Publication
(10) Pub. No.: US 2008/0107869 A1
(43) Pub. Date: May 8, 2008

(54) METHODS OF MAKING ELECTROFORMS, MOUNTING PLATES THEREFORE, PRODUCTS MADE THEREFROM

(76) Inventors: Paul William Buckley, Scotia, NY (US); Kenneth Paul Zarnoch, Scotia, NY (US); Brett Michael Dening, Glen, NY (US)

Correspondence Address: CANTOR COLBURN, LLP, 20 Church Street, 22nd Floor, Hartford, CT, 06103, US

(21) Appl. No.: 11/557,659

(22) Filed: Nov. 8, 2006

(51) Int. Cl. B32B 3/02; C25D 17/00; C25D 1/20

(52) U.S. Cl. 428/156; 205/67; 204/279

(57) ABSTRACT

Disclosed herein are mounting plates and methods for making an electroforms. In one embodiment, the master comprises an edge, a back, a master area, and a pattern having a pattern area. The mounting plate comprises a cutout having a cutout size that is smaller than the master area and larger than the pattern area, and an electrically conductive over-plate area extending around the cutout, between the cutout and an outer edge of the mounting plate. In one embodiment the method comprises: attaching a master to a mounting plate, masking the edge and the back of the master and portions of the mounting plate that will be exposed to plating material, other than the over-plate area, plating the pattern to form the electroform having an edge thickness, and removing the electroform from the master.

### BACKGROUND

This disclosure generally relates to methods for forming an electroform, and, more specifically to mounting plates used in forming the electroform.

Electroforming involves an electrochemical process that uses an anode (which may supply metal for deposition), an electrolyte, and a substrate (which acts as a cathode). An electrical current to the anode and cathode is controlled to manage the deposition of the metal onto the substrate to create a metal replica of various shapes and textures. In another example, electroforms can be made from a complex micromachined master. The replicas (or micromachined master) can be used to mass-produce plastic articles with precise microstructure using processes such as printing, embossing, and casting. For example, these replicas can be employed in the production of data storage media such as CDs, DVDs, and the like.

In backlight computer displays or other display systems, optical films are often used to direct light. For example, in backlight displays, light management films use prismatic structures (often referred to as microstructure) to direct light along a viewing axis (i.e., an axis substantially normal to the display). Directing the light enhances the brightness of the display viewed by a user and allows the system to consume less power in creating a desired level of on-axis illumination. Films for turning or directing light can also be used in a wide range of other optical designs, such as for projection displays, traffic signals, and illuminated signs. The prismatic structures are generally formed in a display film by replicating a metal tool, mold, or electroform having prismatic structures disposed thereon, via processes such as stamping, molding, embossing, or UV-curing. It is generally desirable for the display film and the mold to be free from defects so as to facilitate a uniform luminance of light. Since such structures serve to strongly enhance the brightness of a display, any defects, even if they are small (on the order of 10 microns), can result in either a very bright or very dark spot on the display, which is undesirable. The mold and the display films are therefore inspected to eliminate defects.

Molds such as, for example, electroforms are generally used for manufacturing light management films such as prism sheets for use in liquid crystalline displays. In general, such light management films have at least one microstructured surface that refracts light in a specific way to enhance the light output of the display. Since these films serve an optical function, the surface features must be of high quality with no roughness or other defects. This microstructure is first generated on a master, (e.g., a silicon wafer, glass plate, metal drum, or the such) and is created by one of a variety of processes such as photolithography, etching, ruling, diamond turning, or others. Since this master tends to be expensive to produce and fragile in nature, tooling or molds are typically reproduced off of this master, which in turn serve as the molds from which plastic microstructured films are mass-produced. These tools can be metal copies grown via electroforming processes, or plastic copies formed via molding-type processes. Tools copied directly from the master are called 1^{st}-generation (sub-master), copies of these tools are called 2^{nd}-generation (sub-master), etc. In general, multiple copies can be made of every tool made at any generation, leading to a geometric growth in number of tools with each generation—i.e. a “tooling tree” is produced. Each generation is an inverted image of the previous generation. If the desired final product is a “positive” geometry, then any generation of tooling that is a negative can be used as a mass-production replication tool. If the master is manufactured as a negative, then any even-generation mold can be used for mass-production.

Metallic tools, often in the form of thin flat sheets known as electroforms, are used to produce transparent films with the complimentary surface structure through a transfer molding operation. These electroform tool copies are reproduced from a master by means of electroplating metal to a desired thickness onto the surface of the master followed by separation of the copy from the master yielding an electroform with the complimentary surface structure. This electroform in turn may be copied through another electroplating process and subsequent separation. If a master tool is defective, however, then every subsequent electroform will be defective. In order to generate a flat, defect-free electroform copy, the master electroform must be held in a fixed position so as to maintain flatness, e.g., to avoid deformations such as bends, kinks, warps, and twists. Should the master deform, the deformations will be imparted into the new electroform copy, rendering both the electroform master and electroform copy useless.

There is a continuing need for mounting plate designs and for electroform production processes that enable the successful production of numerous electroforms from a single master.

### BRIEF SUMMARY

Disclosed herein are mounting plates, methods of making electroforms, electroforms made therefrom, and products made from the electroforms. In one embodiment, the master comprises an edge, a back, a master area, and a pattern having a pattern area. The mounting plate comprises a cutout having a cutout size that is smaller than the master area and larger than the pattern area, and an electrically conductive over-plate area extending around the cutout, between the cutout and an outer edge of the mounting plate. In one embodiment the method comprises: attaching a master to a mounting plate, masking the edge and the back of the master and portions of the mounting plate that will be exposed to plating material, other than the over-plate area, plating the pattern to form the electroform having an edge thickness, and removing the electroform from the master.

In another embodiment, a method for making an electroform comprises: attaching a master to a non-electrically conductive mounting plate with an electrically conductive fastener, masking the edge of the master, plating the pattern to form the electroform having an edge thickness, and removing the electroform from the master. The master can comprise an edge, a back, a master area, and a pattern having a pattern area. The mounting plate can comprise a recess extending around the master, between the master and an outer edge of the mounting plate, and an electrically conductive insert disposed in the recess, wherein the recess comprises a tab that extends toward the cutout and contacts the fastener.

In yet another embodiment, a method for making an electroform comprises: attaching a master to a mounting plate with a fastener, masking the edge of the master and portions of the mounting plate that will be exposed to plating material, other than the over-plate area, plating the pattern to form the electroform having an edge thickness, and removing the electroform from the master. The master can comprise an edge, a master area, and a pattern having a pattern area. The mounting plate can comprise an electrically conductive over-plate area extending around the master, between the master and an outer edge of the mounting plate.

In one embodiment, an electroform comprises: a pattern in a pattern area, a non-pattern area disposed around the pattern area, and an edge with an edge thickness without processing the edge. The electroform has a mean thickness, wherein the edge thickness is different than the mean thickness by less than or equal to about ±10%.

In one embodiment, a mounting plate for an electroform comprises: a section configured to receive the master, an electrically conductive over-plate area extending around the section, between the section and an outer edge of the mounting plate, a first electrically non-conductive area between the section and the over-plate area, and a second electrically non-conductive area between the over-plate area and the outer edge.

The above described and other features are exemplified by the following figures and detailed description.

### BRIEF DESCRIPTION OF THE DRAWINGS

Refer now to the figures, which are exemplary, not limiting, and wherein like numbers are numbered alike.

FIG. 1 is one embodiment of an electroforming process map.

FIG. 2 is a front view of an embodiment of an electroform mounted on an embodiment of a mounting plate.

FIG. 3 is a cross-sectional side view of FIG. 2 taken along lines A-A.

FIG. 4 is a front view of another embodiment of a mounting plate.

### DETAILED DESCRIPTION

Many electroforming processes produce electroforms that have non-uniform thickness, particularly at the edges of the electroform. As a result, the electroform is either made oversized and trimmed to size, and/or the electroform is further processed to attain a substantially uniform thickness. In other words, subsequent to plating, the edge of an electroform would need to be shaved, removed, or otherwise processed to remove a bead that would form around the edge of the electroform during the plating process. These processes create waste, and increase labor and processing costs.

The mounting plate and process described herein enable the production of an electroform with a uniform edge thickness without further processing. In other words, without trimming or otherwise processing the edge, the electroform has a uniform edge thickness. Additionally, since uniformity is attained without further processing, electroforms can be produced having substantially the same size as the master, again, saving cost.

In one embodiment, a method for making an electroform comprises: attaching a master (i.e., a version of an electroform from which copies are made) to a mounting plate with a fastener, masking an edge and a back of the master and portions of the mounting plate that will be exposed to plating material, other than the over-plate area, plating the pattern to form the electroform, and removing the electroform from the master. The mounting plate comprises a cutout and an over-plate area extending around the cutout, between the cutout and an outer edge of the mounting plate. The cutout has size that is smaller than the master area and larger than the pattern area.

In another embodiment, a method for making an electroform comprises: attaching a master to a non-electrically conductive mounting plate with an electrically conductive fastener, masking an edge of the master and a back of the master, plating the pattern to form the electroform having an edge thickness, and removing the electroform from the master. The master comprises a pattern having a pattern area and a master area. The mounting plate comprises: a cutout, a recess extending around the cutout, between the cutout and an outer edge of the mounting plate, and an electrically conductive insert disposed in the recess. The cutout has size that is smaller than the master area and larger than the pattern area. The recess comprises a tab that extends toward the cutout and contacts the fastener.

In yet another embodiment, a method for making an electroform comprises: attaching a master to a mounting plate with a fastener, masking the edge of the master and portions of the mounting plate that will be exposed to plating material, other than the over-plate area, plating the pattern to form the electroform having an edge thickness, and removing the electroform from the master. The master comprises an edge, a master area, and a pattern having a pattern area. The mounting plate comprises an electrically conductive over-plate area extending around the master, between the master and an outer edge of the mounting plate.

The above methods can be employed to produce electroforms with uniform edge thickness. For example, the edge thickness is different than a mean thickness of the electroform by less than or equal to about ±10%, or, even a difference of less than or equal to about ±5%. Additionally, the electroform can have an electroform area that is greater than or equal to about 90% of the master area, or even that is greater than or equal to about 95% of the master area. The cutout can have a cutout area that is about 50% to about 90% of the master area, or even that is about 60% to about 80% of the master area. The over-plate area can have a width of about 3 mm to about 35 mm, or more particularly, about 4 mm to about 20 mm, and even more particularly about 4 mm to about 15 mm. Also, an adhesive (e.g., a silicone adhesive) can be used in the masking of the back of the master. In any of these embodiments, the over-plate area can extend around all outer edges of the mounting plate.

In one embodiment, an electroform comprises: a pattern in a pattern area, a non-pattern area disposed around the pattern area, and an edge with an edge thickness without processing the edge. The electroform has a mean thickness wherein the edge thickness is different than the mean thickness by less than or equal to about ±10%.

In one embodiment, a mounting plate comprises: a section configured to receive a master, an electrically conductive over-plate area extending around the section, between the section and an outer edge of the mounting plate, a first electrically non-conductive area between the section and the over-plate area, and a second electrically non-conductive area between the over-plate area and the outer edge.

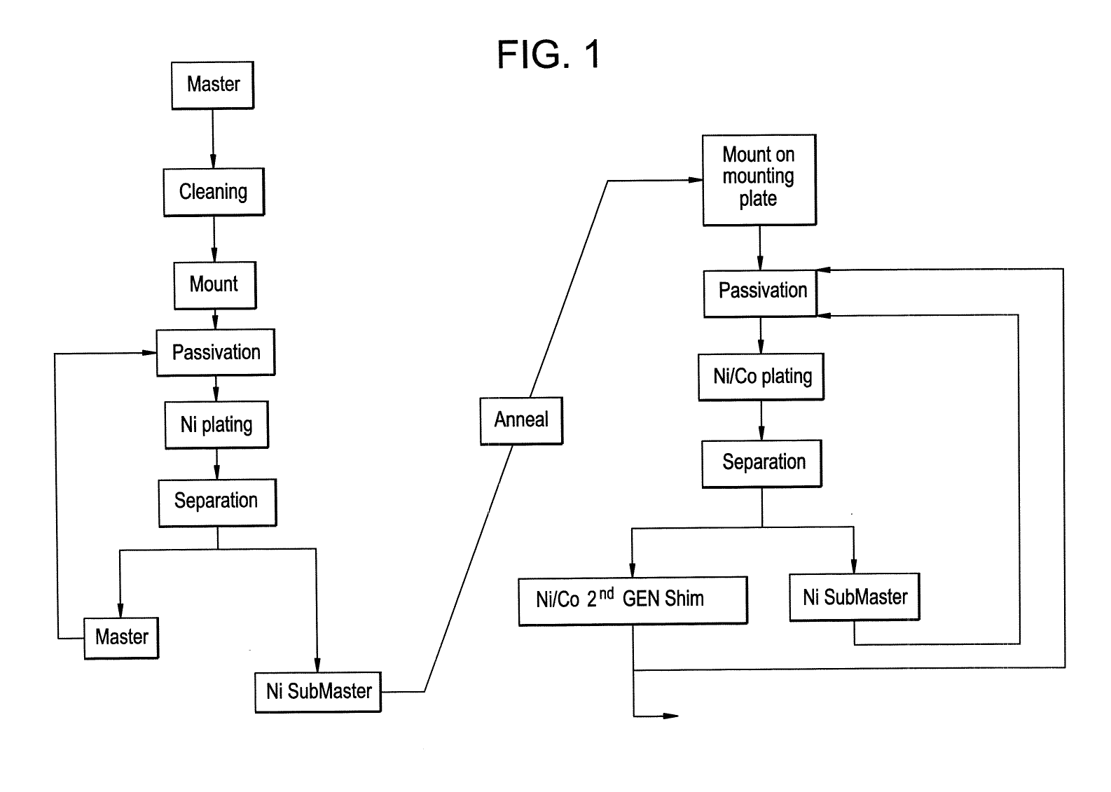

FIG. 1 is a process map of one embodiment of an electroforming process for making a sub-master and a 2^{nd} generation sub-master. The process comprises forming a master having a pattern disposed in an external surface thereof. The pattern can be produced in various fashions, e.g., photolithography, machining, etching, cutting, milling, scribing, among other techniques. The master can be cleaned (before and/or after mounting the master to a mounting plate), e.g., washed with organic solvents, water, acid, and/or base.

Master electroforms can be mounted into a 5-sided box and fixed in place by means of an adhesive, whereas the backside of the electroform makes intimate contact with the back of the box. Adhesives can be in the form of a double-sided tape or a curable glue such as an epoxy or a silicone sealant. The edges along the perimeter of the electroform are then taped down to the box to assure a seal so that no treatment solution or plating material (e.g., plating solution) can leak behind the electroform. The problem with this design is that after only a few electroform copies have been made, the master electroform can begin to delaminate, i.e., the adhesives fail, and the master electroform then buckles and bends. These distortions are then copied into the new electroform, rendering them useless. In addition, liquid treatment solutions and/or plating solutions can leak behind the master electroform causing additional damage.

Another problem encountered with the box-mounting design is non-uniformity of metal thickness, whereas the metal edges along the perimeter, and especially the corners, of the depositing electroform copy where it meets the master electroform tend to be very thick, and even beaded, relative to the mean thickness of the depositing electroform. Due to the extreme thickness, the edges of the electroform copy must be mechanically trimmed off, reducing the overall size of the electroform copy. Additionally, the metal depositing at the corners can often be burned and/or extremely stressed. The latter condition often leads to delamination of the electroform copy from the master, further reducing the useable area of the electroform copy.

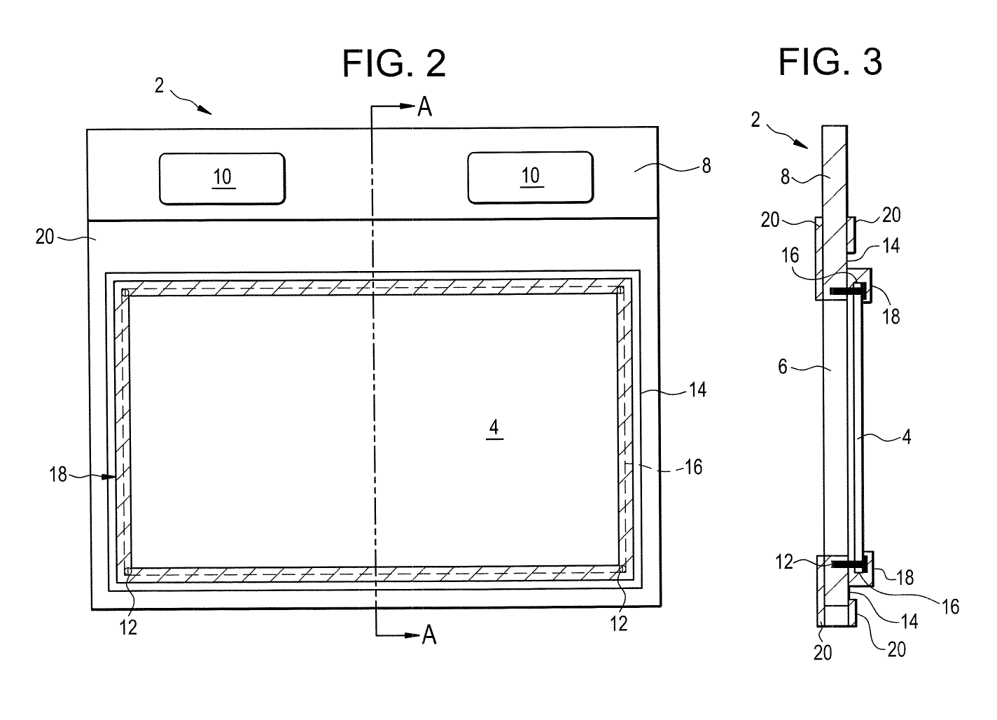

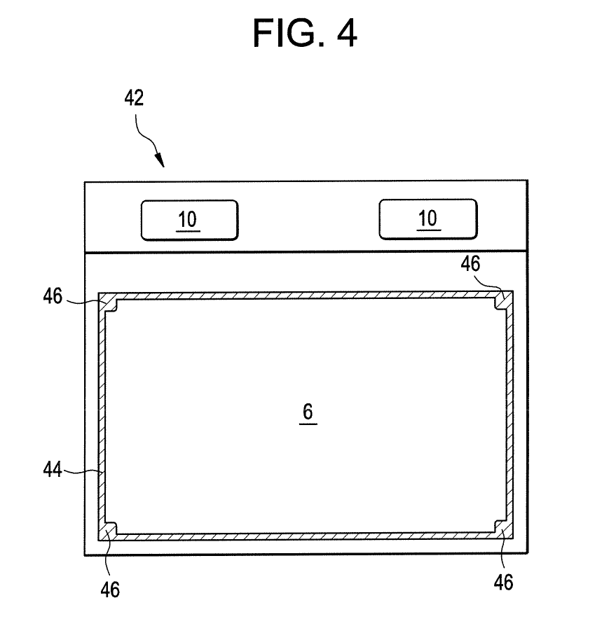

In some embodiments, the master electroform is fixed to the mounting plate over the major cutout area by means of fasteners. Referring to FIGS. 2-4, the mounting plate 2, 42 is provided, whereas the overall dimensions of the plate are larger than the master electroform 4. The mounting plate 2, 42 comprises a cutout 6 that is smaller than the master electroform 4. The size of the cutout can range from a cutout 6 that is equivalent to the size of the area of the master electroform 4 comprising the pattern to a size that is only smaller than the master electroform 4 by the width of fastener(s) 12. For example, the cutout 6 can have a cutout area that can range from a size that is sufficient to inhibit the solution and/or adhesive from damaging the master to a size that enables the attachment of the master to the plate; e.g., the size can be about 30% to about 95% or so, of the area of the master 4, or, more specifically, about 50% to about 95% of the area of the master 4, or, even more specifically, about 60% to about 80% of the area of the master 4. The cutout 6 enables the elimination of the use of adhesives and sealants between the master 4 and a plating box, and the elimination of hidden areas that could trap treatment solution and/or plating material (e.g., plating solution). The adhesives and sealants have been shown to fail and lead to distortions in the master.

The fasteners, which mechanically hold the master electroform to the mounting plate so that the master remains ridged during electroplating, optionally, provides an electrical conductivity pathway between the master and the mounting plate. Some possible fasteners include connectors, pins, screws, bolts, clamps, rivets, and so forth, as well as combinations comprising at least one of the foregoing.

In some embodiments, the mounting plate 2 can comprise a conductive material, e.g., nickel, iron, copper, and combinations comprising at least one of the foregoing, such as stainless steel. To avoid plating of the mounting plate 2, besides the over-plate area 14 and area(s) that will not be disposed into the plating solution, the mounting plate 2 can be masked. Various masking materials compatible with the plating environment as well as the mounting plate 2 and master 4 can be employed. Some exemplary masking materials include vinyls, polyimides, acrylics, epoxies, and polyesters, among others, as well as combinations comprising at least one of the foregoing. These materials can be in the form of a coating (e.g., of a curable paint or powder), and/or tape. Polyester tape has been found to be chemically resistant and consequently reusable for several plating cycles. The adhesive on the tape can comprise various adhesives compatible with the plating environment, such as silicone. The mask can be applied to the back of the master and the mounting plate and the perimeter of the front of the mounting plate to define the plating area for the electroforming step.

In another embodiment, the mounting plate 42 can comprise a non-conductive material (e.g., a ceramic, plastic (such as polyvinyl chloride), and combinations comprising at least one of the foregoing). In this embodiment, the over-plate area comprises a conductive insert 44 disposed in a recess such that, when the master 4 is attached to the mounting plate 42, an electrical communication path is established therebetween. The electrical communication can be established via tab(s) 46 that physically contact the fastener(s) (not shown) to form the electrical pathway. Here, since the mounting plate 42 is not electrically conductive, masking of the areas of the mounting plate 42 that will contact the plating solution is avoided.

The width of the over-plate area 14 (also referred to as the “thief area”) and the insert 44 is based upon the size of the master and the width of the electrically non-conductive area (e.g., the masked area 18) disposed between the exposed portion of the master and the over-plate area 14 or the insert 44. For example, the width can be about 3 mm to about 35 mm, or, more specifically, about 4 mm to about 20 mm, or, even more specifically, about 4 mm to about 15 mm, and yet more specifically, about 5 mm to about 10 mm. Similarly, the masking (e.g., non-conductive area) disposed between the exposed portion of the master and the over-plate area 14 or the insert 44 can have a sufficient width to attain the desired electroform edge thickness. This width can be the same or different than the over-plate area width.

The mounting plate 2, 42 can be dimension to include an upper portion 8 that is meant to remain outside of the plating area (e.g., to remain above the liquid level when disposed in a plating solution). This upper portion 8 optionally contains smaller cutout(s) 10 that can be useful as handles.

Once the master 4 is attached to the mounting plate 2, 42, with the fasteners 12, the outer edge of the master (e.g., the edge of the master where it overlaps the mounting plate, including the mounting points and fasteners; illustrated by the dotted line 16 in FIG. 2) can be masked. The masked area 18 is outside of the pattern, covers the outer edge 16 of the master 2, 42, and extends to the over-plate area 14. If the mounting plate 2 is electrically conductive, besides an over-plate area 14, all areas of the mounting plate 2 that will be within the plating area can be masked via mask 20 (e.g., a second electrically non-conductive area between the over-plate area 14 and the outer edge of the mounting plate). Additionally, to avoid plating of the backside 22 of the master 4, the backside 22 can also be masked, e.g., with a masking material as described above.

Not to be limited by theory, the over-plate area 14 can be left mask-free to equalize the electrical field near the edge of the master 4 during the plating process. By using the unmasked, over-plate area 14, a substantially more uniform electroform can be produced. For example, this configuration avoids the formation of a bead and/or deformation at the edge of the electroform. Additionally, the edge thickness of the electroform different than a mean thickness of the electroform by less than or equal to about ±10%, or, more specifically, less than or equal to about ±5%. As a result, the steps of trimming of the edges of the electroform or otherwise processing the edges of the electroform can be eliminated. Furthermore, since trimming is avoided, the electroform produced in this process can have an overall area that is substantially similar to the area of the master 4, e.g., the electroform can have an area that is greater than or equal to about 90% of the master's area, or, more specifically, greater than or equal to about 95% of the master's area.

The mounted, masked, master can then be plated (e.g., disposed in the plating solution), thereby forming an electroform (e.g., a sub-master). The sub-master can be removed by peeling it from the master. It is desirable to uniformly remove the sub-master without twisting or torquing the sub-master. Twisting, torquing, and other non-uniform removal can damage the pattern on the surface of the sub-master and potentially even damage the surface of the master.

To further facilitate the separation, the surface of the master can be passivated which helps to prevent the replica (i.e., sub-master) from adhering to the surface of the master. Possible passivation techniques include the formation of a separation layer (such as an oxide and/or hydroxide layer) over the master surface, electrostatic cleaning, and/or by chemical passivation techniques. Formation of a separation layer can comprise an electrolytic oxidation process wherein the electrolytic current and voltage are applied to form a controlled thickness separation layer. Chemical passivation can comprise immersing the master surface in a solution for a controlled period of time. The particular solution is dependent upon the master composition. Some possible solutions include alkali metal hydroxide solutions, chromate (such as potassium dichromate), among others.

For example, the surface of the master can optionally be rinsed with Simple Green solution (commercially available from Sunshine Makers, Inc., located in Huntington Beach, Calif.) and then sprayed with a saponin solution to promote wetting of the surface. A potassium dichromate solution (e.g., about 5 grams per liter (g/l)) can be applied to the surface of the master (e.g., poured over the surface). The potassium dichromate is then rinsed from the master surface to form a passivated master. Optionally, the saponin and potassium dichromate applications can be repeated as desired.

The passivated master can then be plated in various processes, including an electroforming process. The electroforming process can be performed in an electroforming tank where the outer surface of the master functions as the cathode through electrical contacts. The anode can be constructed from various metals, including the metal to be deposited during metallization. For example, a nickel or nickel alloy anode can be used if nickel is the desired metal in the metallization process. For example, the passivated master can be placed into an electroforming solution. A rectifier in electrical communication with the anode and cathode can be maintained constant during this process or it can be adjusted. The electroforming can be accomplished in up to about 24 hours.

The solution in the electroforming tank can be an aqueous solution comprising a surfactant agent, a pH of less than or equal to about 6, and optionally a hardening agent. The solution will further comprise the metal(s) to be deposited. One embodiment of a solution can comprise about 60 grams per liter (g/l) to about 100 g/l of metal sulfamate (e.g., the metal to be deposited), sufficient acid to attain a pH of less than or equal to about 6, a sufficient amount of surfactant agent to affect wetting of the metallic surface to be coated, and optionally a hardening agent, e.g., to control stress in the deposit. For example, the solution can comprise about 70 g/l to about 90 g/l nickel sulfamate, about 25 g/l to about 35 g/l boric acid, and sufficient sulfamic acid to attain a pH of about 2 to about 5.0.

When a current is applied to the system, the anodic metal oxidizes to form metal ions which then flow to the cathode (the outer surface of the passivated master) and deposit thereon. The cathode then reduces the metal ion into elemental metal. The following shows the reactions at the anode and cathode for nickel:

anode: Ni⁰−2e⁻→Ni²⁺

cathode: Ni²⁺+2e⁻→Ni

Electroforming of other metals also go through similar reactions at the anode and cathode. Some of the possible metals for the electroforming process include, but are not limited to, nickel (Ni), cobalt (Co), copper (Cu), silver (Ag), iron (Fe), aluminum (Al), titanium (Ti), iridium (Ir), gold (Au), chromium (Cr), beryllium (Be), tungsten (W), tantalum (Ta), molybdenum (Mo), platinum (Pt), palladium (Pd), gold (Au), among others, as well as alloys comprising at least one of the foregoing metals, and mixtures comprising at least one of the foregoing metals. Some possible alloys include a nickel-phosphorus (NiP) alloy, a palladium-phosphorus (PdP) alloy, a cobalt-phosphorus (CoP) alloy, a nickel-cobalt (NiCo) alloy, a gold-cobalt alloy (AuCo), and a cobalt-tungsten-phosphorus (CoWP) alloy.

Electroforming process parameters include solution temperature, composition, and rectifier voltage. Regarding the temperature, the solution in the electroforming tank can optionally be heated to about 30° C. to about 80° C., or, more specifically, about 35° C. to about 60° C., or, even more specifically, about 40° C. to about 50° C. The rectifier can be used to apply a sufficient voltage to the electrodes to induce an electric current to cause anodic oxidation of the metal to be deposited, and to reduce the metal ions at the cathode. For the formation of a Ni or Ni alloy layer, for example, the current density can be about 2 amperes per square foot (ASF) to about 100 ASF or so, or, more specifically, about 5 ASF to about 60 ASF or, even more specifically, about 10 ASF to about 30 ASF.

The exposure time in the electroforming tank while the current is applied can be determined based upon the particular metal layer to be formed and the desired thickness of that layer. The layer thickness can be based upon a desired structural integrity to enable the layer to be removed from the master as well as to be used to produce next generation sub-masters, and based upon the size of the features formed in the surface of the layer. Thicknesses can be up to and exceeding about 500 micrometers (μm) or so, or, more specifically, about 50 μm to about 400 μm, or, even more specifically, about 100 μm to about 300 μm, and, yet more specifically, about 150 μm to about 250 μm.

By controlling the processing parameters of the electroplating, the thickness of the deposited metal layer can be adjusted. The thickness of this metal layer can be calculated from the equation:

$$T = ( \frac{M \cdot I \cdot t}{\vert Z \vert F ρ A} )$$

where: T=thickness of the electroformed layer;
M=the molar mass of the metal;
I=the current;
t=the time of electroformation;
   |Z|=the absolute value of the valence of the metal;
F=Faraday constant;
ρ=the density of the metal; and
A=the surface area to be covered by the metal.
   This equation gives a theoretical maximum thickness assuming 100% efficiency of the cathode. However, because electrodes are not always 100% efficient, the actual thickness is usually less than that calculated by the equation. Generally, the efficiency of an electrode is about 95% to about 99% depending on the material used as well as other factors.

Once the desired thickness is achieved, the rectifier is switched off and the plate is removed from the electroforming tank. Optionally, the coated master is rinsed, e.g., with water (such as deionized water (i.e., water that has been treated with an ion exchange resin to remove ions therefrom)), and retained in an inert environment (e.g., an environment that does not chemically interact with the sub-master surface to change the surface chemistry under the environmental conditions). Some possible inert environments include nitrogen, argon, helium, vacuum, and others, depending upon the environment.

The sub-master, comprising a negative of the structures on the master, can be separated from the master. For example, if a separation tape (also know as plater's tape) has been disposed on the master, the tape can be removed from the master, exposing the master as well as an edge of the sub-master. The sub-master can then be peeled from the master. The master can again be used to produce additional generations of sub-masters by repeating the masking, passivation, plating, and separation.

The sub-master can be used in the plating process to create additional electroforms so long as the surface to be plated is properly passivated. Passivation helps to prevent the next generation sub-master from adhering to the surface of the prior generation sub-master once formed. Controlling various parameters of the passivation layer affect the life of the sub-master (e.g., the number of copies that can be made from the sub-master while retaining macroscale, microscale, and nanoscale resolution). Macroscale refers to the reproduction in the next generation sub-master of the overall geometry of the replica, such as flatness and visual uniformity. This macrostructure has a size of approximately 1 millimeter (mm) to about 1 meter (m) or the entire size of the part being formed; i.e. of a size scale easily discerned by the human eye. Microscale refers to the reproduction in the next generation sub-master of microstructures on the surface, such as hemispheres, corner-cubes, microlenses, prisms, and so forth, as well as combinations comprising at least one of the foregoing. These microstructures have a size of less than or equal to about 1 mm, or, more specifically, greater than 100 nanometers (nm) to about 1 mm. Nanoscale resolution refers to the reproduction in the next generation sub-master of nanostructures forming part of a surface feature, such as at or near corners or a peak or valley of a surface feature, or the optical smoothness of a facet of a feature. These nanostructures have a size of less than or equal to about 500 nm, or, more specifically, less than or equal to about 100 nm, or, even more specifically, less than or equal to about 20 nm, and yet more specifically, about 0.5 nm to 10 nm.

The parameters that can be controlled that can affect the life of the sub-master include the chemical composition, the thickness, density, and distribution of the passivation layer. By controlling the passivation layer, greater than or equal to about 50, or, more specifically, greater than or equal to about 75, or, even more specifically, greater than or equal to about 100, and even expect hundreds of sub-masters from nickel alloy electroform replicas having the nanoscale resolution can be produced.

The particular passivation employed for the sub-master is dependent upon the sub-master material. Passivation can be accomplished, for example, by contacting the sub-master with a solution (e.g., an aqueous solution) and anodically charging the sub-master. The aqueous solution can comprise a surfactant and be alkaline (e.g., have an alkalinity of greater than or equal to pH 8, or, more specifically, greater than or equal to about 10, or, even more specifically, a pH of about 12 to about 14).

The surfactant can be any material that reduces the surface tension of water and aids the wetting of the metal surface. Possible surfactants include cationic, non-ionic, anionic, as well as combinations comprising at least one of the foregoing surfactants. Anionic surfactants include, for example, carboxylates, sulfonates, sulfates, and phosphate esters. Cationic surfactants include, for example, amines and quaternary salts. Non-ionic surfactants include, for example, polyoxyethylene derivatives of fatty alcohols, carboxylic esters, and carboxylic amides.

The alkalinity can be attained with a material capable of promoting or causing the formation of metal oxides and/or metal hydroxides on the surface of the sub-master, e.g., an oxidation species. Some possible oxidation species that can be employed include alkali metal hydroxides (such as sodium hydroxide, potassium hydroxide, and the like), as well as combinations comprising at least one of the foregoing.

Once the sub-master is disposed in the aqueous solution, it is anodically charged to convert metallic components on the surface thereof to metal oxides and/or metal hydroxides, thereby forming a passivation layer. The sub-master can be charged until the passivation layer has a thickness of about 10 Angstroms (Å) to about 500 Å, or, more specifically, about 15 Å to about 60 Å, or, even more specifically, about 20 Å to about 40 Å. The amount of current applied to the sub-master can be about 1 ASF to about 40 ASF, or, more specifically, about 5 ASF to about 25 ASF, or, even more specifically, about 5 ASF to about 10 ASF. This current can be applied for a period of about 1 minute to about 5 minutes, or, more specifically, about 1 minute to about 3 minutes.

This passivation technique has been found particularly useful with Ni containing sub-masters (e.g., comprising Ni and/or a Ni alloy (e.g., NiCo, NiCr, among others)). For the Ni containing sub-masters, a greater number of successful replication of the nanostructures was achieved when employing a solution comprising an alkali metal hydroxide instead of a chromate. Possible alkali metal hydroxides include sodium hydroxide, potassium hydroxide, and the like, as well as combinations comprising at least one of the foregoing.

Once passivated, the sub-master can optionally be dried (passively and/or actively), and then plated. Plating can be in various fashions that are capable of applying a layer of metal onto the surface of the electroform and thereby replicating the surface features thereof. For example, the passivated electroform can be placed in a solution in the electroforming tank. Electrical connection is made to the surface of the sub-master comprising the surface features so that it becomes the cathode. This solution in the electroforming tank can comprise about 60 g/l to about 100 g/l of metal sulfamate (e.g., the metal to be deposited), sufficient acid to attain a pH of less than or equal to about 6, a sufficient amount of surfactant agent to affect wetting of the metallic surface to be coated, and optionally a hardening agent, e.g., to control stress in the deposit. For example, the solution can comprise about 70 g/l to about 90 g/l metal alloy sulfamate (e.g., nickel-cobalt sulfamate, cobalt-tungsten sulfamate, and so forth), about 25 g/l to about 35 g/l boric acid, and sufficient sulfamic acid to attain a pH of about 2 to about 5.0. The anode, as stated above, optionally comprises the metal or metals to be deposited on the sub-master surface.

When a current is applied to the system, the anodic metal oxidizes to form metal ions which then flow to the cathode (the surface of the passivated sub-master) and deposit thereon. The cathode then reduces the metal ion into elemental metal. Once the desired thickness of the deposited metal has been achieved, the current is ceased and the plated sub-master is removed from the tank.

The thickness of the layer formed on the sub-master, which is a positive of the sub-master, is dependent on its use, for example, to produce further generations of sub-masters or to produce final product. The thickness can be greater than the depth of the features on the sub-master and sufficient to attain the structural integrity for its intended use. The layer thickness can be based upon a desired structural integrity to enable the layer to be removed from the master as well as to be used to produce next generation sub-masters. Thicknesses can be up to and exceeding about 500 micrometers (μm) or so, or, more specifically, about 50 μm to about 400 μm, or, even more specifically, about 100 μm to about 300 μm, and, yet more specifically, about 150 μm to about 250 μm.

In some applications it may be desirable to form a multi-layer electroform, e.g., for the final generation tooling (i.e., the electroform employed to make final product such as prismatic films). For example, a single electroform that is produced with layers of different compositions. Each layer can have the same or a different thickness. For example, the surface layer (i.e., the layer the side of the electroform comprising the surface features), can be a material that enhances the release of the final product from the electroform, and/or that inhibits undesired reactions on the surface, while the back layer can be a material that enhances the structural integrity of the electroform. One or more intermediate layers can also be employed, e.g., to enhance the bonding of the other layers.

For example, a surface layer comprising gold (e.g., gold, a gold alloy, or a gold mixture) can be plated onto a sub-master, and then backing layer comprising nickel (e.g., nickel, a nickel alloy, or a nickel mixture) can be overplated (plated over the gold). In this process, the sub-master is passivated as described above. The passivated sub-master can then be disposed into an electroplating bath comprising the desired surface-layer material (e.g., gold). The surface layer can then be formed utilizing the sub-master as the cathode in the electroplating process. Once the desired surface layer thickness has been achieved, the sub-master can then be disposed in a second electroplating solution to form the second layer onto the surface layer. Again, the sub-master can be used as the cathode in the electroplating process. The thickness of the second layer is dependent upon a desired overall electroform thickness and the function of this second layer, e.g., as an intermediate layer or as the backing layer. Although passivation of the sub-master between the electroplating solutions is possible, the various layers can be formed without this passivation so that each layer of the multilayer electroform is firmly bonded to the next.

The thickness of the surface layer is dependent upon the particular application. The surface layer can have a thickness of millimeters in some applications, while it can be nanometers thick in others. For example, where the surface layer is employed to attain a chemical inertness on the surface of the electroform while controlling the costs of the layer (e.g., while limiting the amount of gold in the layer), the surface layer can have a thickness of up to about 10 μm or so, or, more specifically, about 1 nm to about 1 μm, or, even more specifically, about 5 nm to about 500 nm, and yet more specifically, about 10 nm to about 100 nm. An intermediate layer can have a thickness of up to about 50 micrometers (μm) or so, or, more specifically, about 1 nm to about 25 μm, or, even more specifically, about 10 nm to about 1 μm. The backing layer can have a thickness of up to about 500 micrometers (μm) or so, or, more specifically, about 50 μm to about 400 μm, or, even more specifically, about 100 μm to about 300 μm.

For example, a passivated sub-master can be passivated in an alkaline solution by anodically charging the sub-master. Once a passivation layer has been formed, the passivated electroform can be removed from the alkaline solution and optionally rinsed. The passivated electroform can then be disposed in the surface layer electroplating solution comprising gold cyamide, silver cyamide, and so forth. A current is applied, and, with the passivated electroform acting as the cathode, metal ions (e.g., gold, silver, cobalt, nickel, and so forth, depending on the composition of the solution) are deposited on the surface of the sub-master.

Once a desired surface layer thickness has been attained, the coated electroform is moved to the next electroplating solution comprising the metals to be disposed in the subsequent layer (e.g., comprising nickel, cobalt, and so forth). Optionally, the coated electroform can be rinsed (e.g., with deionized water) prior to entering the subsequent electroplating solution. Furthermore, maintenance of the coated electroform in an inert environment can be desirable (i.e., an environment that will not cause a reaction on the surface layer). In the subsequent electroplating solution, the coated sub-master again functions as the cathode and receives metal ions on its surface. This process can be repeated until the desired number of layers and layer thicknesses has been attained.

The particular post-treatment(s) employed prior to using a sub-master in the production of product are dependent upon the particular product to be formed. For example, to produce an acrylate film comprising the desired nanoscale resolution, the surface energy of the sub-master can be reduced (e.g., of a nickel containing sub-master). Desirably, the post-treatment renders the surface of the electroform hydrophobic, and as such, will not attract polar molecules such as organic monomers and in particular acrylate monomers.

High surface energy surfaces can attract polar molecules and become wetted with them. In the case of water being the polar species, the surface is wetted with water, there being a low wetting angle, and the surface is said to be “hydrophilic.” Low surface energy surfaces will not attract polar molecules and will not become wetted with them. If the surface is rendered to be of a low surface energy then polar species like water will bead-up on the surface, and the surface is said to be “hydrophobic.”

The surface energy of the sub-master surface can be reduced by treating the sub-master with a solution having a pH of less than or equal to 6, or, more specifically, less than or equal to about 5, or, even more specifically, about 2 to about 5. Optionally, a cathodic current can be applied. The cathodic current can have a current density of about 1 ASF to about 60 ASF, or, more specifically, about 2 ASF to about 30 ASF or, even more specifically, about 2 ASF to about 10 ASF.

The sub-master can also, optionally, be treated to remove particulate(s) and/or staining (e.g., after the sub-master has been used to make product). This treatment can be before the sub-master has been used to produce product, and/or to refurbish the sub-master. This post-treatment can comprise rinsing the sub-master with water (e.g., deionized water), acidic media, and/or caustic media. For example, the sub-master can be placed in a bath containing deionized water, aqueous acid (e.g., a pH of less than or equal to about 6, or, more specifically, a pH of about 2 to about 5), and/or caustic media (e.g., a pH of greater than or equal to about 8, or, more specifically, a pH of about 8 to about 14).

Once removed from the bath, the sub-master can be rinsed with water (e.g., deionized water), for example, to remove particulates and metal salts. The sub-master can then be actively (e.g., contacted the heat, gas, and/or another method of facilitating drying) and/or passively dried. Optionally, the sub-master can be oven dried at a temperature that does not adversely affect the surface features or surface chemistry.

When used to make a product (e.g., to mass produce product such as LCD displays to diffuse or collimate light), the electroform (e.g., an electroform that has been post-treated with a cathodic current), can be attached to a calendaring roll. Product material can then be applied to the electroform. For example, a desired film material(s) can be extruded (or co-extruded) such that the material that will comprise the surface feature is disposed in direct physical contact with the electroform. The material can be cured and removed from the electroform to form the product. As an alternative, and/or in addition to the extrusion, preformed film(s) can be employed. Here, the film to be imprinted with the surface features can be sufficiently heated to enable the formation of the surface features into the film surface.

Possible product materials include plastics (e.g., thermoplastics and/or thermosets), such as acrylates, polycarbonates, polyesters, terephthalates (e.g., poly(ethylene terephthalate)), polyimides (e.g., polyetherimides), polystyrenes (e.g., ABS, ASA, and so forth), polyolefins, polyacrylonitrile (PAN), polyamide (PA), polyvinyl chloride (PVC), resorcinol, polyarylenes (e.g., polyarylene ether), polyacrylonitrile, polyethers, as well as combinations comprising at least one of the foregoing plastics. Various plastics can be combined in a single layer. These plastics can also be disposed in separate layers to form the product wherein one of the layers comprises the desired surface features. If multilayers are employed, adjacent layers comprise materials that provide sufficient adhesion between the layers for the desired application (e.g., that will not delaminate under use conditions for the product). Optionally, coatings and the like can be applied to the product after the surface features have been disposed in the surface thereof. Possible films that can be produced with the present process include those disclosed in U.S. Published Application No. 2003/0214728 A1 to Olczak, U.S. Published Application No. 2004/0109663 A1 to Olczak, and others.

The following examples are provided merely to further illustrate the electroforms and mounting plates and the methods described herein, and are not intended to limit the scope hereof.

### EXAMPLES

### Example 1

### Passivation in a Caustic Solution With Anodic Current

Sample 1, a nickel sub-master electroform having a microstructure comprising a plurality of channels and grooves of about 1μm to about 37 μm in depth, was passivated by immersion into an aqueous solution for 4 minutes at 25° C. while applying an anodic current density of 4 ASF. The aqueous solution comprised 20 g/l potassium hydroxide and 0.5 g/l sodium lauryl sulfate and had a pH of 13.5. The sub-master was removed, rinsed with deionized water, and then dried. The sub-master was then plated with a nickel-cobalt (NiCo) alloy by electroforming a layer that was about 100 μm in thickness. After electroforming, the plated sub-master was rinsed and dried, and the nickel-cobalt electroform was readily peeled from the sub-master, showing complete removal and no visible damage to the microstructures when examined under a microscope at up to 40×. It is also noted that samples have been examined to a magnification of 100× without visible damages, and even passed SEM (scanning electron microscope) review at 100K× (100,000×).

### Example 2

### Passivation of a Nickel Containing Sub-Master

Sample 2, a production-size nickel-cobalt sub-master electroform (a nominal size 40 cm by 65 cm), having a microstructure comprising a plurality of channels and grooves of about 1 μm to about 37 μm in depth, was passivated by immersion into an aqueous solution for 4 minutes at 35° C. while applying an anodic current density of 4 ASF. The aqueous solution comprised 20 g/l of StamperPrep, and had a pH of greater than 13.5. The sub-master was removed, rinsed with deionized water, and then dried. The sub-master was then plated with a nickel-cobalt alloy by electroforming a layer that was about 200 μm in thickness under the same conditions as in Example 1. After electroforming, the plated sub-master was rinsed and dried, and the nickel-cobalt electroform was readily peeled from the sub-master, showing complete removal and no visible damage to the microstructures when examined under a microscope.

Sample 2 was then recycled through the passivation step and electroforming step a total of 65 times, thus generating 65 electroforms all of which separated cleaning and wholly showing complete removing and with no visible damage to the microstructures when examined under a microscope.

### Example 3

### Post-Treatment by Immersion in a Caustic Solution, Followed by Rinsing and Drying

An electroform, such as Sample 1, can be immersed in a caustic solution having a pH of about 8 to 14, at 40° C., for 1 to 5 minutes, rinsed with deionized water, and dried. The electroform can then be placed on a roll for use in the formation of acrylate films. A liquid coating mixture, comprising UV-curable acrylate monomer(s), oligomer, photoinitiator, and non-reactive additive(s), can be pressed into the electroform surface by a backing film, (e.g., a plastic film, such as polycarbonate, polyester, and so forth, as well as reaction products comprising at least one of the foregoing, and combinations comprising at least one of the foregoing), and can be cured to fix the microstructures into the surface. The film, with the cured acrylate microstructures, can then be separated from the roll. It has been observed that electroforms, such as Sample 1, (that have only been rinsed, but not post-treated to reduce the surface energy), i.e., with a high surface energy, cause permanent sticking of minute domains of the acrylate coating during the production of the transparent film. These minute domains accumulate on the electroform surface, ultimately changing the surface features, and thereby effectively causing the loss of the desired nanoscale resolution.

### Example 4

### Post-Treatment by Immersion in an Acidic Solution and Application of a Reverse Current (Cathodic Current)

Sample 4, a NiCo sub such as Sample 1, can be post-treated, e.g., to reduce the surface energy. Sample 7 can be immersed in an acidic solution for 1 to 5 min at 40° C., while applying a cathodic current density of 4 ASF. The acidic solution can comprise Citranox™, and can have a pH of about 4. The electroform can then be placed on a roll for use in the formation of acrylate films. A liquid coating mixture, comprising UV-curable acrylate monomer(s), oligomer, photoinitiator, and non-reactive additive(s), can be pressed into the electroform surface by a backing film, (such as polycarbonate, polyester, and so forth), and can be cured to fix the microstructures into the surface. The film, with the cured acrylate microstructures, can then be separated from the roll. This acrylate film has been observed to have a nanoscale resolution.

### Example 5

### Treatment by Immersion in a Caustic Solution (After Production of Product with the Electroform)

Sample 5, a NiCo sub-master such as Sample 1, can be post-treated, e.g., to reduce the surface energy. Sample 8 can be immersed in a caustic media for 1 to 5 min at 40° C., while applying a cathodic current density of 4 ASF. The caustic solution can comprise StamperPrep™, sodium hydroxide etc., and can have a pH of about 8 to about 14. The electroform can then be placed on a roll for use in the formation of acrylate films. A liquid coating mixture, comprising UV-curable acrylate monomer(s), oligomer, photoinitiator, and non-reactive additive(s), can be pressed into the electroform surface by a backing film, (such as polycarbonate, polyester, and so forth), and can be cured to fix the microstructures into the surface. The film, with the cured acrylate microstructures, can then be separated from the roll. It was further observed that the caustic soak and reverse current, when applied to the nickel or nickel-cobalt electroforms, also eliminated particulate and staining defects from the microstructured electroform surface, which resulted in tool yield improvements.

### Example 6

### Passivation of a Nickel Containing Sub-Master with a Solution Comprising Dichromate

A nickel-cobalt sub-master electroform having a microstructure comprising a plurality of channels and grooves of about 1 μm, to about 37 μm in depth was passivated by immersion into an aqueous solution comprising 5 g/l potassium dichromate for 5 minute at 25° C. while agitating the solution. The sub-master was removed and rinsed with deionized water. The sub-master was then plated with a nickel-cobalt alloy by electroforming a layer that was about 100 μm in thickness. After electroforming, the plated sub-master was rinsed and dried, and the nickel-cobalt electroform was peeled from the sub-master. Examination under a microscope showed the microstructures to be partially damaged, whereas the very finest structures at the sharpest corners of the peaks were torn from the electroform and remained on the sub-master, thus causing visible defects and loss of optical performance. The dichromate passivation process was inadequate to passivate the nickel containing sub-master in that not all areas (in particular, the deepest valleys on the sub-master), were passivated sufficiently to allow complete removal of the entire electroform copy.

### Example 7

### Electroplating Without the Over-Plate Area

A stainless steel master, nominally 30 cm by 30 cm in dimension, was masked with platers tape so that an area of nominal dimensions 14 cm by 20 cm remained exposed for plating. The plate was immersed in a 20 g/L aqueous solution of StamperPrep™ for 1 minute while applying an anodic current of 4 ASF. The master was rinsed with deionized water and then immersed in a nickel-cobalt plating solution and plated for about 5 hours. The deposited electroform was then separated from the stainless steel master, rinsed, and dried in air. Thickness measurements were then taken of three regions: the very outer edge, at 0.5 cm in from the edge, and at 3 cm in from the edge. The values are reported in Table 1 and show that the outer edge is more than 3 times thicker than the mean electroplate thickness.

### Example 8

### Electroplating with the Over-Plate Area

A stainless steel master, nominally 30 cm by 30 cm in dimension, was masked with platers tape so that an area of nominal dimensions 14 cm by 20 cm remained exposed for plating. Additionally, an area of stainless steel master in the shape of a frame nominally 0.6 cm wide surrounded the central plating area of the plate, being separated from the central plating area by 0.3 cm using platers tape. The plate was immersed in a 20 g/L aqueous solution of StamperPrep™ for 1 minute while applying an anodic current of 4 ASF. The master was rinsed with deionized water, and then immersed in a nickel-cobalt plating solution and plated for about 5 hours. The deposited electroform was then separated from the stainless steel master, rinsed, and dried in air. Thickness measurements were then taken of three regions: the very outer edge, at 0.5 cm in from the edge, and at 3 cm in from the edge. The values are reported in the Table 1 and show that the outer edge thickness is less than 10% thicker than the mean electroplate thickness (wherein 3 cm from the edge represents the mean electroplate thickness).

TABLE 1

| Plating | Thickness (micrometers) | | |
|---|---|---|---|
| Configuration | 3 cm from edge | 0.5 cm from edge | edge |
| Example 7 | 323 | 560 | 1,150 |
| Example 8 | 313 | 318 | 336 |

The electroforms prepared as described herein can be use to produce acrylate films, e.g., display films with microscale features. For such brightness enhancement films, the key optical property to be measured is the on-axis luminance of these films in an LCD backlight assembly, which was measured with using the following protocol. A Teijin D120 (commercially available from Tsujiden Co., Ltd., Japan) bottom diffuser was placed on backlight (i.e., LG Phillips LP121X1 single CCFL notebook backlight), and a vertical prism film was placed over the bottom diffuser (i.e., the lower prism film was oriented with the prisms running vertically) while the horizontal prism film was placed over the vertical prism film (i.e., the upper film was placed with prisms running horizontally). The inverter was a Taiyo Yuden LS 390 (commercially available from Taiyo Yuden (U.S.A.) Inc., Schaumburg, Ill.). A thermocouple was used to monitor the temperature of the active backlight in real-time while letting the system equilibrate (until the average temperature did not change more than 0.1° F. over a 5 minute duration). Once equilibrium was attained, the Microvision SS220 display analysis system (commercially available from Microvision, Auburn, Calif.) output the luminance in units of candelas per square meter (also known as “nits”). These units were converted to “relative luminance units” compared with a BEF-II film standard (commercially available from Minnesota Mining and Manufacturing Co., St. Paul, Minn.). It is noted that the Microvision software included: luminance uniformity—measured on-axis luminance across 13 points of the backlight; and view angle—measured luminance as a function of angle at the center point of the backlight.

A 3 ^{rd}-generation electroform designated M-1-1-1 (i.e. the 1^{st} 3^{rd}-generation copy of the 1^{st} 2^{nd}-generation copy of the 1^{st} 1^{st}-generation copy of the master “M”) was prepared according to the process described above to produce 67 4^{th}-generation copies of itself. Copies number 2 and 67 were used to produce display films that were tested for luminance. The films from the 2^{nd} copy had an average normalized luminance of 103.5% with a standard deviation of 0.19%, while the films from the 67^{th} copy had an average normalized luminance of 103.2% with a standard deviation of 0.22%, which makes them statistically equal at a 95% confidence limit. In other words, even after 67 production cycles, there was no decrease in quality of the film produced.

The present electroplating process is more effective than previous processes, e.g., the replication accuracy has been maintained for greater than or equal to about 100 replicas. For example, due to the passivation process, the replicas (i.e., next generation sub-masters) readily separate from the sub-master after the plating process without loss of surface features.

Additionally, the post-treatment process for treating the sub-master prior to using the sub-master in production of a product (such as a display film), enables the reproducible production of a more regular geometric pattern than when the sub-master has been post-treated with deionized water and a caustic media (pH of about 8 to about 14). This post-treatment, which uses a cathodic current and acidic media, is particularly useful on electroforms used in the production of articles from a polar material. The caustic media can be employed with the electroform between product production runs, to reduce, and possibly eliminate, particulate and staining defects from the microstructured electroform surface; resulting in tool yield improvements.

It is noted that the mounting techniques, and/or passivation techniques disclosed above can be used with various processes for producing an electroform (e.g. a sub-master), and are not limited to the electroplating technique discussed herein. Other possible processes for depositing the metal material onto the master or sub-master to produce the next generation sub-master include plasma spraying, vapor deposition (e.g., chemical vapor deposition), electroless plating.

As previously noted, the electroforms can be used to produce objects comprising microstructures with nanoscale resolution, such as films, and in particular, films comprising light-reflecting elements (e.g., retroreflective elements). Possible microstructures include light-reflecting elements such as cube-corners (e.g., triangular pyramid), trihedral, hemispheres, prisms, ellipses, tetragonal, grooves, channels, microlenses, and others, as well as combinations comprising at least one of the foregoing. These films can be used in various applications, e.g., in light management applications (e.g., as a part of a light management article). For example, the film can be used in to direct, diffuse, and/or polarize light. The films can be brightness enhancement films used in backlight computer displays or other display systems. Some other potential applications include graphical applications (e.g., labels, flooring graphic applications, and so forth), automotive overlays, instrument clusters, tridimensional molded parts (e.g., with multicolor graphics that can be backlit), and so forth. The films can be used alone or in multilayer structures. For example, in applications such as those described in U.S. Published Application No. 2004/0228141 A1 to Hay et al.

Previously, subsequent to plating, the edge of an electroform would need to be shaved, removed, or otherwise processed to remove a bead that would form around the edge of the electroform during the plating process. The present process enables the production of substantially uniform electroforms. For example, the electroform can comprise a patterned area, a non-pattern area located around the pattern area, and an edge. The edge thickness can be produced such that it is different than the mean thickness by less than or equal to about ±10% without processing the edge (e.g., as produced from the plating solution), or, more specifically, less than or equal to about ±5% different without processing the edge.

Ranges disclosed herein are inclusive and combinable (e.g., ranges of “up to about 25 wt %, or, more specifically, about 5 wt % to about 20 wt % ”, is inclusive of the endpoints and all intermediate values of the ranges of “about 5 wt % to about 25 wt %,” etc.). “Combination” is inclusive of blends, mixtures, alloys, reaction products, and the like. Furthermore, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the state value and has the meaning dictated by context, (e.g., includes the degree of error associated with measurement of the particular quantity). The suffix “(s)” as used herein is intended to include both the singular and the plural of the term that it modifies, thereby including one or more of that term (e.g., the colorant(s) includes one or more colorants). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for making an electroform, comprising:
attaching a master to a mounting plate, wherein the master comprises an edge, a back, a master area, and a pattern having a pattern area, and wherein the mounting plate comprises
a cutout having a cutout size that is smaller than the master area and larger than the pattern area; and
an electrically conductive over-plate area extending around the cutout, between the cutout and an outer edge of the mounting plate;
masking the edge and the back of the master and portions of the mounting plate that will be exposed to plating material, other than the over-plate area;
plating the pattern to form the electroform having an edge thickness; and
removing the electroform from the master.

2. The method of claim 1, wherein the edge thickness is different than a mean thickness of the electroform by less than or equal to about ±10%.

3. The method of claim 2, wherein the edge thickness is different than the mean thickness by less than or equal to about ±5%.

4. The method of claim 1, wherein the electroform has an electroform area that is greater than or equal to about 90% of the master area.

5. The method of claim 4, wherein the electroform area is greater than or equal to about 95% of the master area.

6. The method of claim 1, wherein the cutout has a cutout area that is about 50% to about 90% of the master area.

7. The method of claim 6, wherein the cutout area is about 60% to about 80% of the master area.

8. The method of claim 1, wherein silicone adhesive is used in the masking of the back.

9. The method of claim 1, wherein the over-plate area has a width of about 3 mm to about 35 mm.

10. The method of claim 9, wherein the width is about 4 mm to about 20 mm.

11. The method of claim 10, wherein the width is about 4 mm to about 15 mm.

12. The method of claim 1, wherein the over-plate area extends around all outer edges of the mounting plate.

13. A method for making an electroform, comprising:
attaching a master to a non-electrically conductive mounting plate with an electrically conductive fastener, wherein the master comprises an edge, a back, a master area, and a pattern having a pattern area, and wherein the mounting plate comprises
a recess extending around the master, between the master and an outer edge of the mounting plate; and
an electrically conductive insert disposed in the recess, wherein the recess comprises a tab that extends toward the cutout and contacts the fastener;
masking the edge of the master;
plating the pattern to form the electroform having an edge thickness; and
removing the electroform from the master.

14. The method of claim 13, wherein the mounting plate further comprises a cutout, wherein the cutout has size that is smaller than the master area and larger than the pattern area; and further comprising masking the back of the master.

15. An electroform, comprising:
a pattern in a pattern area;
a non-pattern area disposed around the pattern area; and
an edge with an edge thickness without processing the edge;
wherein the electroform has a mean thickness, and
wherein the edge thickness is different than the mean thickness by less than or equal to about ±10%.

16. A method for making an electroform, comprising:
attaching a master to a mounting plate with a fastener, wherein the master comprises an edge, a master area, and a pattern having a pattern area, and wherein the mounting plate comprises an electrically conductive over-plate area extending around the master, between the master and an outer edge of the mounting plate;
masking the edge of the master and portions of the mounting plate that will be exposed to plating material, other than the over-plate area;
plating the pattern to form the electroform having an edge thickness; and
removing the electroform from the master.

17. A mounting plate for an electroform master having an edge, a back, a master area, and a pattern, and the pattern has a pattern area, the mounting plate comprising:
a section configured to receive the master;
an electrically conductive over-plate area extending around the section, between the section and an outer edge of the mounting plate;
a first electrically non-conductive area between the section and the over-plate area; and
a second electrically non-conductive area between the over-plate area and the outer edge.

18. The mounting plate of claim 17, further comprising a cutout, wherein the cutout has size that is smaller than the master area and larger than the pattern area.

19. The mounting plate of claim 17, wherein the electrically conductive over-plate area comprises
a recess extending; and
an electrically conductive insert disposed in the recess, wherein the recess comprises a tab that is configured to contact a fastener that will contact the mounting plate.
